(19) United States
(12) Patent Application Publication
(10) Pub. No.: US 2023/0228288 A1
(43) Pub. Date: Jul. 20, 2023

(54) TRAY ASSEMBLY

(71) Applicant: JIN SUN GEE PLASTICS CO., LTD., Tainan City (TW)

(72) Inventor: Chung-Jen CHENG, Tainan City (TW)

(73) Assignee: JIN SUN GEE PLASTICS CO., LTD., Tainan City (TW)

(21) Appl. No.: 17/579,363

(22) Filed: Jan. 19, 2022

(51) Int. Cl. F16B 12/10; A47D 3/00

(52) U.S. Cl. CPC F16B 12/10; A47D 3/00

(57) ABSTRACT

A tray assembly includes a base body having a top surface, and a socket member extending downwardly from the top surface and defining a socket hole having a top opening that opens at the top surface.

A resilient member is disposed in the socket hole. A top cover is movably disposed in the socket hole above the resilient member. The top cover is movable upward and downward to switch between a first position and a second position. In the first position, the top cover covers the top opening and is limited from moving downward. In the second position, the top cover is movable downward from the first position, and the resilient member is pressed and stores energy for returning the top cover to the first position.

### FIELD

The disclosure relates to a tray assembly, and more particularly to a tray assembly for a baby walker.

### BACKGROUND

FIGS. 1 and 2 illustrate an existing tray assembly 1 to be assembled to a baby walker (not shown). The tray assembly 1 includes an annular tray 11, two spaced mounting structures 12 protruding upward from a top surface of the annular tray 11, and a plurality of toys 13 (of which two are shown) removably connected to the mounting structures 12.

Each mounting structure 12 includes two latching slots 120 (only one is shown in FIG. 2) diametrically opposite to each other. Each latching slot 120 has a first slot portion 121 opening upward, and a second slot portion 122 communicating with and extending angularly from the first slot portion 121.

Each toy 13 has a main body 131 and two engagement blocks 132 disposed around the main body 131 and diametrically opposite to each other.

Through the engagement blocks 132 and the latching slots 120, the toys 13 can be assembled to or disassembled from the mounting structures 12. However, because the mounting structures 12 protrude upward from the annular tray 11, when the toys 13 are removed from the mounting structures 12, the mounting structures 12 protruding from the annular tray 11 are not beneficial for aesthetic appearance of the annular tray 11 and for placement of other things thereon. Especially, the latching slots which are uncovered are exposed to dust and dirty substances.

### SUMMARY

Therefore, an object of the disclosure is to provide a tray assembly that can alleviate at least one of the drawbacks of the prior art.

According to the disclosure, a tray assembly includes a base body, and a mounting unit. The base body has a top surface. The mounting unit includes a socket member, a resilient member, and a top cover.

The socket member extends downwardly from the top base surface and defines a socket hole having a top opening that opens at the top base surface.

The resilient member is disposed in the socket hole.

The top cover is movably disposed in the socket hole above the resilient member. The top cover is movable upward and downward to switch between a first position and a second position.

In the first position, the top cover covers the top opening and is limited from moving downward.

In the second position, the top cover is movable downward from the first position, and the resilient member is pressed and stores energy for returning the top cover to the first position.

### BRIEF DESCRIPTION OF THE DRAWINGS

Other features and advantages of the disclosure will become apparent in the following detailed description of the embodiment with reference to the accompanying drawings, of which:

FIG. 1 is a perspective view illustrating an existing tray assembly;

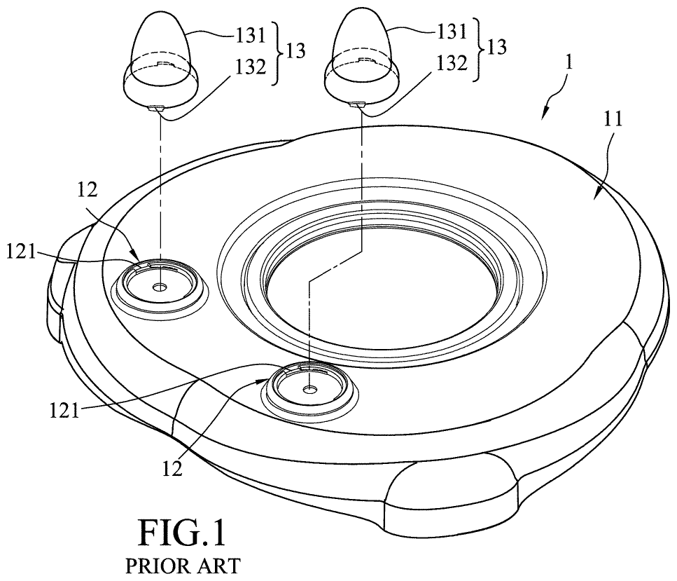

FIG. 2 is a sectional view of the existing tray assembly;

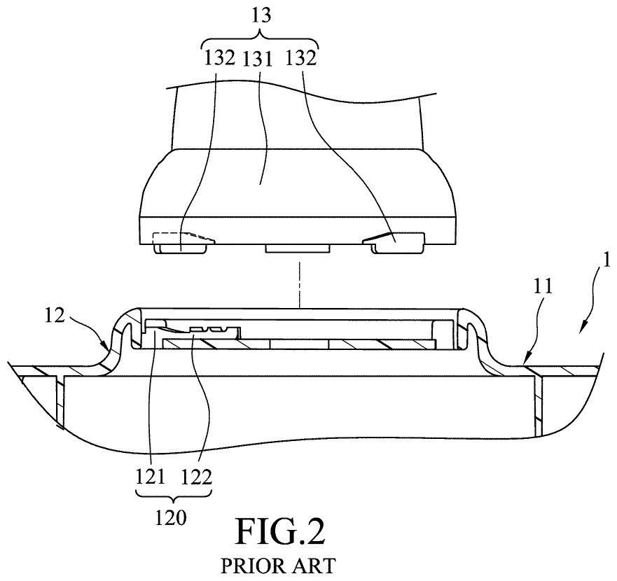

FIG. 3 is a perspective view of a tray assembly according to an embodiment of the disclosure illustrating accessory members to be assembled to a base body;

FIG. 4 is an exploded perspective view of the embodiment, illustrating a top cover, a resilient ember, a rotary operating member, a socket member, and a portion of the base body of the tray assembly;

FIG. 5 is a fragmentary perspective view of the embodiment illustrating a relation between a portion of the socket member and a portion of the rotary operating member;

FIG. 6 is a partially sectional view of the embodiment illustrating the rotary operating member rotated to a first rotated position to limit the top cover in a first position;

FIG. 7 is a view similar to FIG. 6, but taken from another angle;

FIG. 8 is a view similar to FIG. 4, but illustrating the resilient member, the rotary operating member, and the socket member in an assembled state;

FIG. 9 is a view similar to FIG. 6, but illustrating the top cover in the second position when the rotary operating member is rotated to a second rotated position;

FIG. 10 a sectional view of the embodiment, illustrating the accessory member assembled to the socket member when the rotary operating member is in the second rotated position and the top cover is in the second position;

FIG. 11 is a view similar to FIG. 10, but taken from another angle; and

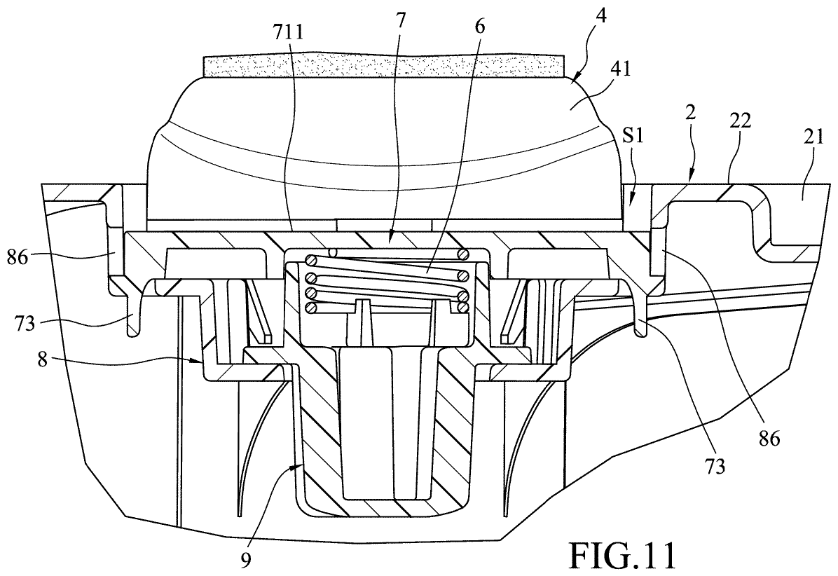

FIG. 12 is a partially top sectional view of the embodiment illustrating the accessory member rotated between an initially inserted position and a secured position.

### DETAILED DESCRIPTION

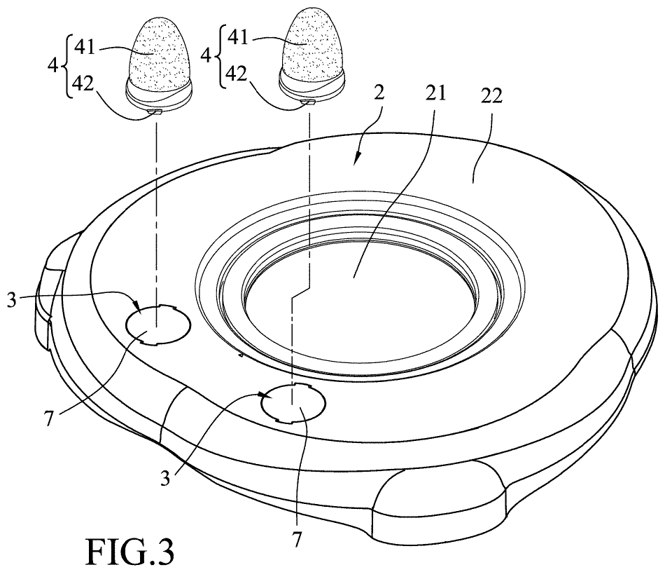

FIGS. 3 to 6 illustrate a tray assembly according to an embodiment of the disclosure for a baby walker. The tray assembly includes a base body 2, a mounting unit 3, an accessory member 4, and a rotary operating member 9.

The base body 2 is substantially in the form of an annular plate shape and has a central hole 21 for receiving a baby, and a top base surface 22 annularly surrounding the central hole 21.

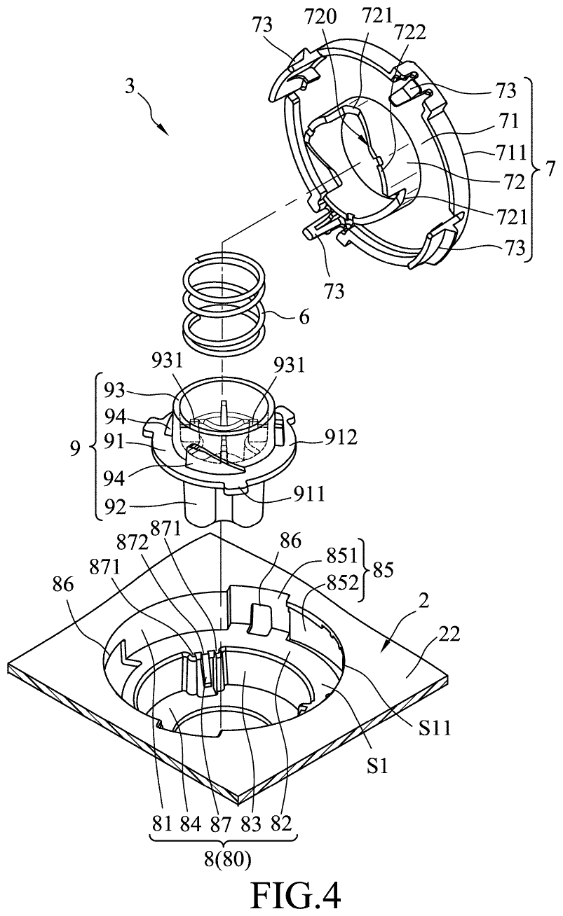

As shown in FIGS. 4 to 8, the mounting unit 3 includes a socket member 8, a resilient member 6, and a top cover 7.

The socket member 8 extends downwardly from the top base surface 22 and defines a socket hole (S1) having a top opening (S11) that opens at the top base surface 22. The socket member 8 has a socket wall 80 extending downwardly from the top base surface 22 and surrounding the socket hole (S1), and two angularly spaced-apart engagement slots 85 indented from the socket wall 80. The socket wall 80 has a first annular support face 82, a first tubular wall portion 81, four angularly spaced latching holes 86, a second tubular wall portion 83, a second annular support face 84, and a plurality of angularly spaced-apart stop members 87.

The first annular support face 82 is disposed below the top opening S11 and faces upward.

The first tubular wall portion 81 extends downward from the top opening (S11) to the first annular support face 82.

The engagement slots 85 are formed in the first tubular wall portion 81 and diametrically opposite to each other. Each engagement slot 85 has a first slot portion 851 indented downwardly from and opening at the top base surface 22, and a second slot portion 852 communicating with and extending angularly from the first slot portion 851. The second slot portion 852 has a top boundary side adjacent to the top base surface 22, a bottom boundary side adjacent to the first annular support face 82, and a distal boundary side angularly opposite to the first slot portion 851.

The latching holes 86 are angularly spaced 90 degrees apart from each other. Each latching hole 86 is disposed below the top base surface 22 and extends through the first annular support face 82 and the first tubular wall portion 81 and thus resembles an L-shape. Two of the latching holes 86 is wider in width than the other two of the latching holes 86 respectively disposed in and communicating the first slot portions 851 of the engagement slots 85.

The second tubular wall portion 83 extends downwardly from an inner periphery of the first annular support face 82.

The second annular support face 84 faces upwardly and extends radially and inwardly from a bottom end of the second tubular wall portion 83.

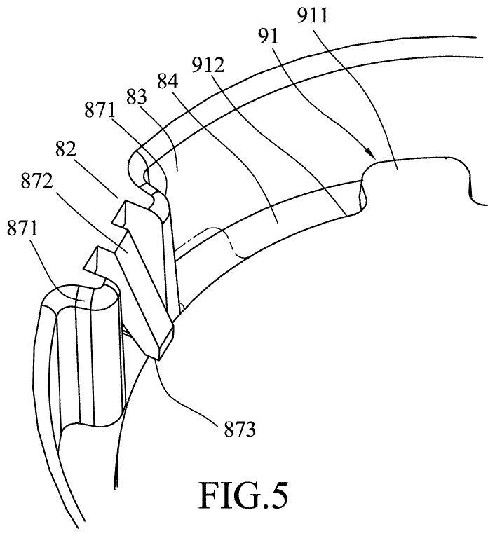

The stop members 87 are disposed between the first and second annular support faces 82, 84 and protrudes radially and inwardly from the second tubular wall portion 83. In this embodiment, the stop members 87 are equidistantly spaced apart from each other. As shown in FIGS. 4 and 5, each stop member 87 has two lateral parts 871 and a central part 872 that inclinedly protrudes beyond the lateral parts 871 and that is notched at its bottom end 873 from the second annular support face 84.

The rotary operating member 9 is disposed in the socket hole (S1) and rotatable relative to the socket member 8 and the top cover 7 (details of the top cover 7 will be described hereinafter). The rotary operating member 9 has a seat portion 91, a knob portion 92, and an upward hollow extension 93.

As shown in FIGS. 4 to 7, the seat portion 91 is rotatably supported by and seated on the second annular support face 84. The seat portion 91 is formed as an annular seat formed with a plurality of radially protruding and angularly spaced tabs 911. Each tab 911 extends into a space between two adjacent ones of the stop members 87 so that rotation of the seat portion 91 is limited. An annular circumferential edge 912 of the seat portion 91 extends into the notched bottom ends 873 of the central parts 872 of the stop members 87 so that the seat portion 91 is retained on the second annular support face 84 and is limited from moving upward and separating from the second annular support face 84.

The knob portion 92 projects downwardly from the seat portion 91 to extend outward from the socket hole (S1) for manual manipulation.

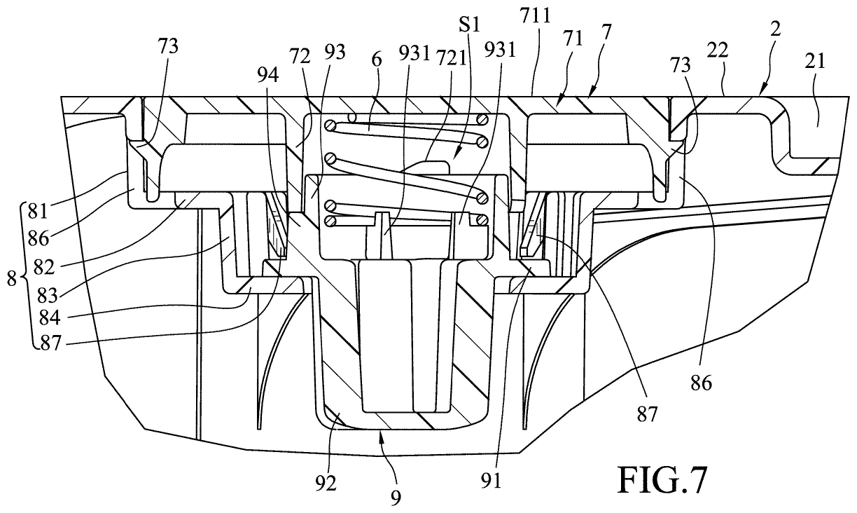

The upward hollow extension 93 extends upwardly from the seat portion 91. In this embodiment, the upward hollow extension 93 is tubular and has an outer surface formed with a plurality of angularly spaced limiting blocks 94. Each of the limiting blocks 94 has a top abutting portion 941, a steep side 942 extending downwardly from an end of the top abutting portion 941, and an inclined portion 943 inclined downwardly from the other end of the top abutting portion 942. As shown in FIGS. 4 and 7, the upward hollow extension 93 further has an inner surface from which a plurality of L-shaped spring seat members 931 extending radially.

The resilient member 6 is disposed in the socket hole (S1). In this embodiment, the resilient member 6 is disposed in and surrounded by the upward hollow extension 93. A bottom end of the resilient member 6 is supported by the spring seat members 931, and an upper end of the resilient member 6 abuts the top cover 7. When being pressed downward by the top cover 7, the resilient member 6 stores energy for pushing the top cover 7 to move upward.

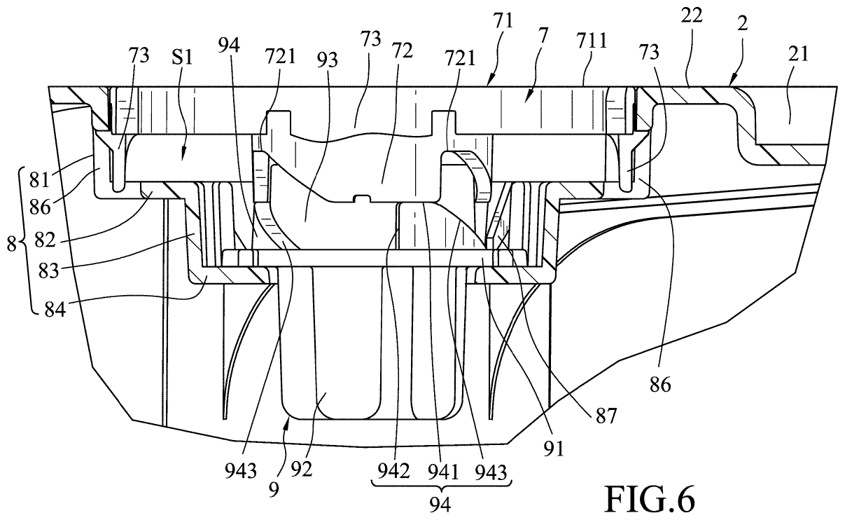

Referring to FIGS. 6 to 8, the top cover 7 is movably disposed in the socket hole (S1) above the resilient member 6. The top cover 7 has a cover portion 71, a downward hollow extension 72, and a plurality of latching legs 73.

The cover portion 71 is substantially in the form of a round plate. The cover portion 71 is movable within the first tubular wall portion 81 above the first annular support face 82 and is seated on the first annular support face 82 when the top cover 7 is moved downward.

The downward hollow extension 72 projects downward from the cover portion 71 to overlap with the upward hollow extension 93 of the operating member 9. In this embodiment, the upward hollow extension 93 is inserted into the downward hollow extension 72. The downward and upward hollow extensions 72, 93 are movable relative to each other in a telescopic manner. The resilient member 6 is disposed within the upward and downward hollow extensions 93, 72. The downward hollow extension 72 is tubular and has a bottom surface 720 opposite to the cover portion 71, a plurality of angularly spaced indentations 721 indenting from the bottom surface 720, and a plurality of nonindented parts 722 each formed between two adjacent ones of the indentations 721. The limiting blocks 94 are situated below the bottom surface 720 of the downward hollow extension 72. Each indentation 721 of the top cover 7 conforms in shape with one of the limiting blocks 94 so that the limiting blocks 94 can be respectively and complementarily received in the indentations 721. The top abutting portion 941 of each of the limiting blocks 94 is abuttable against one of the nonindented parts 722 of the downward hollow extension 72.

The latching legs 73 extend downwardly from an outer periphery of the cover portion 71 and are angularly spaced apart around the downward hollow extension 72. The latching legs 73 are respectively extendable into the latching holes 86 and have barbs engageable with the latching holes 86 to prevent detachment of the latching legs 73 in an upward direction from the latching holes 86. The latching legs 73 are movable upward or downward in the latching holes 86.

As shown in FIG. 3, the accessory member 4 has a main body 41 and two angularly spaced-apart engagement blocks 42 disposed around and protruding outward from the main body 41. The main body 41 can be designed to have a configuration, which can attract infant's attention, for example, a cartoon character, English letter, toy globe, bell or horn, etc.

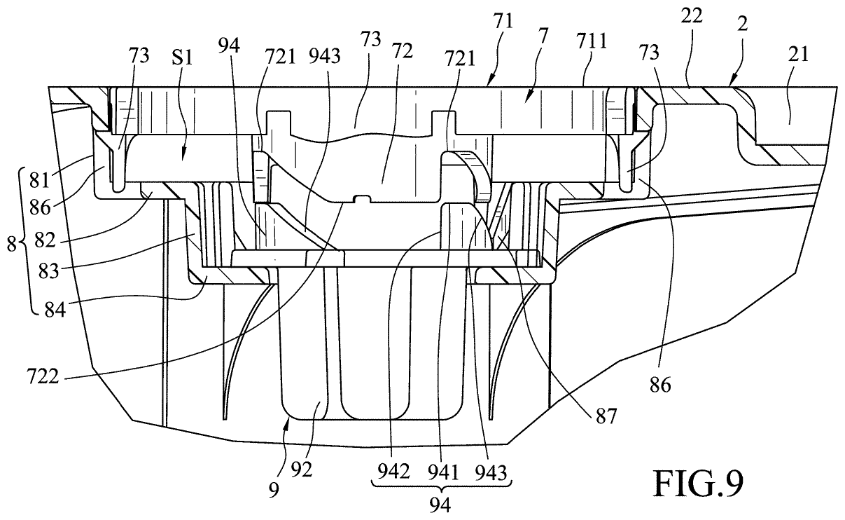

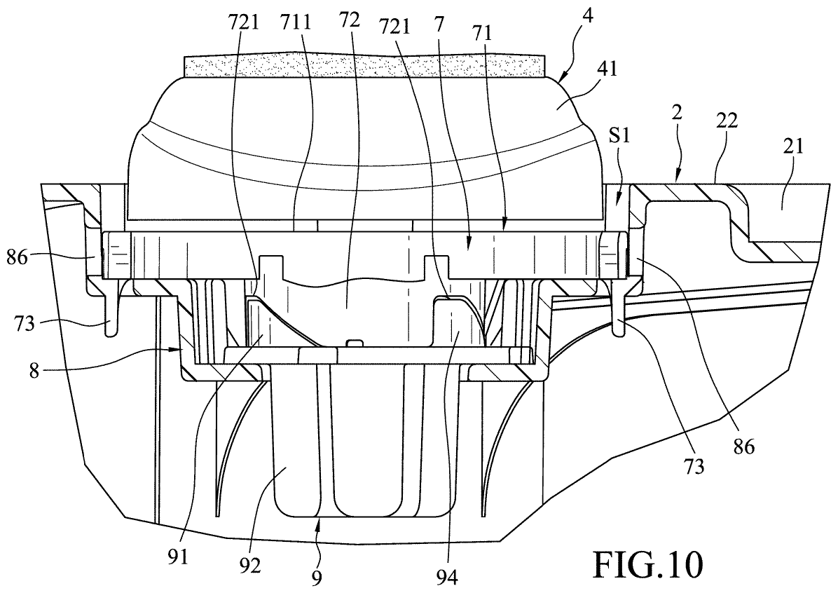

As shown in FIGS. 4, 6, 9, and 10, the rotary operating member 9 is operable, by rotation of the knob portion 92, to rotate relative to the socket member 8 between a first rotated position (see FIGS. 6), where the rotary operating member 9 lifts and limits the top cover 7 from moving downward, and a second rotated position (see FIGS. 9 and 10), where the rotary operating member 9 allows the top cover 7 to move downward. In other words, by rotation of the rotary operating member 9 between the first and second rotated positions, the top cover 7 is movable upward and downward to switch between a first position, where the top cover 7 covers the top opening (S11) and is limited from moving downward, and a second position, where the top cover 7 is movable downward from the first position, and the resilient member 6 is pressed and stores energy for returning the top cover 7 to the first position.

As shown in FIG. 6, in the first rotated position of the rotary operating member 9, the limiting blocks 94 of the rotary operating member 9 are not aligned with the indentation 721 of the top cover 7 and the top abutting portion 941 abuts against a portion of the bottom surface 720 so that the top cover 7 is lifted to the first position and prevented from moving downward. As shown in FIGS. 9 and 10, in the second rotated position of the rotary operating member 9, the limiting blocks 94 are aligned with the indentations 721 of the top cover 7 so that the top cover 7 is allowed to move downward from the first position to the second position.

In this embodiment, the stop members 87 of the socket wall 80 protrude adjacent to the seat portion 91 to limit a rotation angle of the seat portion 91 so that the knob portion 92 can be limitedly rotated back or forth to switch the rotary operating member 9 to the first or second rotated position. In the first position of the top cover 7, a top surface of the cover portion 71 is flush with the top base surface 22 of the base body 2. In the second position of the top cover 7, the accessory member 4 can be removably engaged into the socket hole (S1) above the top cover 7 so that the top cover 7 is pressed downward, the cover portion 71 is lower than the top base surface 22, and the limiting blocks 94 of the rotary operating member 9 are respectively received in the indentations 721 of the top cover 7.

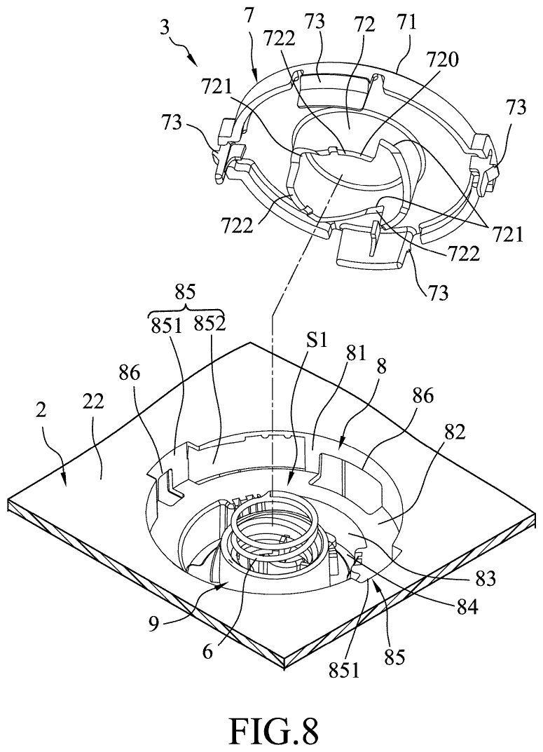

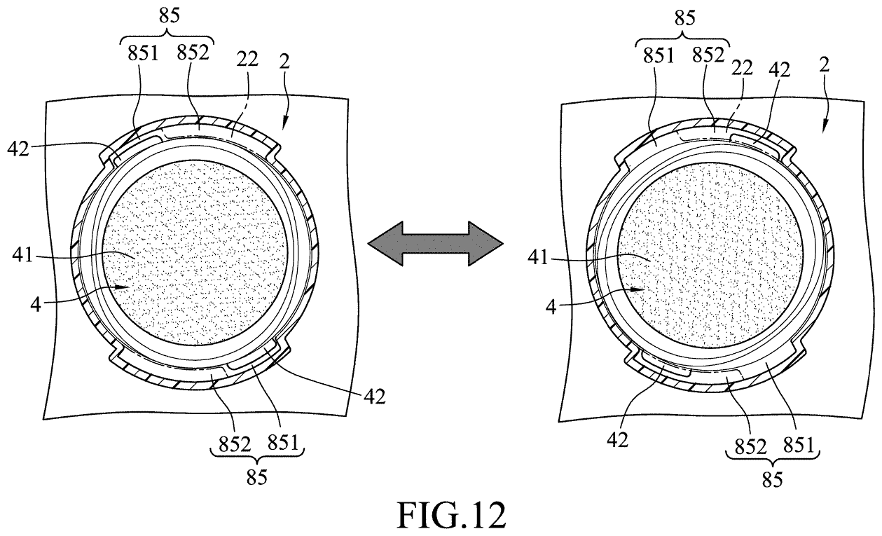

Referring to FIG. 12 in combination with FIGS. 3 and 8, when the accessory member 4 presses the top cover 7 that has been placed in the second position, the accessory member 4 can switch between an initially inserted position (see the left side of FIG. 12) and a secured position (see the right side of FIG. 12). In the initially inserted position of the accessory member 4, the engagement blocks 42 are received in the respective first slot portions 851. When the accessory member 4 is rotated to the secured position, the engagement blocks 42 are respectively limited by the second slot portions 852 of the engagement slots 85 so that the accessory member 4 is prevented from detaching upward from the socket member 8. Noteworthily, each of the engagement blocks 42 is rotatable to move from the first slot portion 851 to the second slot portion 852. Each first slot portion 851 allows one of the engagement blocks 42 to access to or exit from the second slot portion 852 for engagement therewith or disengagement therefrom. To replace the accessory member 4 with another accessory member 4 with a different shape, the accessory member 4 is switched from the secured position to the initially inserted position to be removed from the socket member 8. When the accessory member 4 is removed, the top cover 7 is moved upward by the resilient member 6 to the second position, and the other accessory member 4 can be installed on the mounting unit 3.

Referring back to FIGS. 4, 6, and 7, when the rotary operating member 9 is rotated to the first rotated position, because the limiting blocks 94 of the rotary operating member 9 abut against the nonindented parts 722 of the top cover 7 to lift the top cover 7 to the first position, the cover portion 71 is immobile and flush with the top base surface 22. Therefore, the slot (S1) is covered and prevented from exposure to dust and dirt, and the cover portion 71 and the top base surface 22 constitute a flat surface to support objects.

When the top cover 7 switches to the second position by rotation of the rotary member 9 to the second rotated position, the accessory member 4 is allowed to be installed to the mounting unit 3. After the accessory member 4 is removed from the mounting unit 3, the top cover 7 covers the top opening (S11) and does not protrude outward from the top base surface 22, thereby solving the problem encountered by the prior art.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A tray assembly, comprising:
a base body having a top base surface; and
a mounting unit including
a socket member extending downwardly from said top base surface and defining a socket hole having a top opening that opens at said top base surface,
a resilient member disposed in said socket hole, and
a top cover movably disposed in said socket hole above said resilient member, said top cover being movable upward and downward to switch between a first position and a second position,
wherein, in the first position, said top cover covers said top opening and is limited from moving downward,
wherein, in the second position, said top cover is movable downward from the first position, and said resilient member is pressed and stores energy for returning said top cover to the first position.

2. The tray assembly as claimed in claim 1, further comprising an accessory member removably engaged into said socket hole above said top cover when said top cover is in the second position.

3. The tray assembly as claimed in claim 2, wherein said accessory member has a main body and a plurality of angularly spaced-apart engagement blocks disposed around said main body, said socket member having a socket wall extending downwardly from said top base surface and surrounding said socket hole, and a plurality of angularly spaced-apart engagement slots indented from said socket wall, each of said engagement slots having a first slot portion indented downwardly from and opening at said top base surface, and a second slot portion communicating with and extending angularly from said first slot portion, said first slot portion allowing one of said engagement blocks to access to or exit from said second slot portion for engagement therewith or disengagement therefrom, each of said engagement blocks being rotatable to move from said first slot portion to said second slot portion.

4. The tray assembly as claimed in claim 1, further comprising a rotary operating member disposed in said socket hole and rotatable relative to said socket member and said top cover, said resilient member being disposed in said rotary operating member below said top cover, said rotary operating member being operable to rotate between a first rotated position, where said rotary operating member lifts and limits said top cover from moving downward, and a second rotated position, where said rotary operating member allows said top cover to move downward.

5. The tray assembly as claimed in claim 4, wherein:
said top cover has a cover portion and a downward hollow extension projecting downward from said cover portion;
said socket member further has a socket wall extending downwardly from said top base surface and surrounding said socket hole;
said rotary operating member has a seat portion rotatably supported by said socket wall, and an upward hollow extension extending upwardly from said seat portion to overlap with said downward hollow extension, said downward and upward hollow extensions (72, 93) being inserted one into the other and movable relative to each other in a telescopic manner, said resilient member being disposed within said upward and downward hollow extensions.

6. The tray assembly as claimed in claim 5, wherein:
said upward hollow extension inserted into said downward hollow extension;
said downward hollow extension is tubular and has a bottom surface opposite to said cover portion, and at least one indentation indenting from said bottom surface;
said upward hollow extension is tubular and has an outer surface formed with at least one limiting block situated below said bottom surface of said downward hollow extension;
in the first rotated position, said at least one limiting block of said rotary operating member is not aligned with said at least one indentation of said top cover and abuts against a portion of said bottom surface so that said top cover is lifted to the first position and prevented from moving downward; and
in the second rotated position, said at least one limiting block is aligned with said at least indentation of said top cover so that said top cover is allowed to move downward from the first position to the second position.

7. The tray assembly as claimed in claim 6, wherein said at least one indentation includes a plurality of angularly spaced indentations, said bottom surface of said downward hollow extension further having a plurality of nonindented parts each formed between two adjacent ones of said indentations, said at least one limiting blocks including a plurality of angularly spaced limiting blocks.

8. The tray assembly as claimed in claim 7, wherein each of said limiting blocks has a top abutting portion abuttable against one of said nonindented parts of said downward hollow extension of said top cover, a steep side extending downwardly from an end of said top abutting portion, and an inclined portion inclined downwardly from the other end of said top abutting portion, each of said indentations of said top cover conforming in shape with one of said limiting blocks.

9. The tray assembly as claimed in claim 4, wherein:
said rotary operating member has a seat portion rotatably supported by said socket wall, and a knob portion projecting downwardly from said seat portion to extend outward from said socket hole for manual manipulation; and
said socket wall has a plurality of angularly spaced-apart stop members protruding radially and inwardly therefrom adjacent to said seat portion to limit a rotation angle of said seat portion so that said knob portion is limitedly rotated back or forth to switch said rotary operating member to the first or second rotated position.

10. The tray assembly as claimed in claim 9, wherein said seat portion is formed as an annular seat formed with a plurality of radially protruding and angularly spaced tabs, each of said tabs extending into a space between two adjacent ones of said stop members so that rotation of said seat portion is limited.

11. The tray assembly as claimed in claim 9, wherein:
said socket wall of said socket member has a first annular support face that is disposed below said top opening and faces upward, a first tubular wall portion extending downward from said top opening to said first annular support face, and a plurality of angularly spaced latching holes formed in said first tubular wall portion;
said cover portion is movable within said first tubular wall portion above said first annular support face and is seated on said first annular support face when said top cover is moved downward;
said top cover further has a plurality of latching legs extending downwardly from an outer periphery of said cover portion and angularly spaced apart around said downward hollow extension, said latching legs respectively extending in said latching holes and having barbs engageable with said latching holes to prevent detachment of said latching legs in an upward direction from said latching holes, said latching legs being movable upward or downward in said latching holes.

12. The tray assembly as claimed in claim 11, wherein
said socket wall further has a second tubular wall portion extending downwardly from an inner periphery of said first annular support face, and a second annular support face facing upwardly and extending radially and inwardly from a bottom end of said second tubular wall portion; and
said seat portion of said rotary operating member is seated on said second annular support face.
